(19) United States
(12) Patent Application Publication
(10) Pub. No.: US 2026/0203689 A1
(43) Pub. Date: Jul. 16, 2026

(54) Graphical Neural Network-Based Project Scheduling System for Service Development for Containerized Applications

(71) Applicant: Dell Products L.P., Round Rock, TX (US)

(72) Inventors: Tsehsin Liu, Wellesley, MA (US); Anthony Jreij, Pflugerville, TX (US); James Snyder, Rockledge, FL (US); Matthew R. Cullen, Derry, NH (US)

(21) Appl. No.: 19/017,259

(22) Filed: Jan. 10, 2025

(51) Int. Cl. G06Q 10/0631; G06Q 10/10

(52) U.S. Cl. CPC G06Q 10/06313; G06F 8/71; G06Q 10/0633; G06Q 10/103

(57) ABSTRACT

A system can determine to produce a project schedule for a project of developing a containerized application. The system can input project specification data into a first artificial intelligence model to produce an output that comprises an indication of a user account of a group of user accounts that is responsible for the project, based on a correlation between the project specification data and respective pairs comprising project specifications and responsible user accounts. The system can input the project specification data and a dependency map into a second graphical neural network model that comprises agents, wherein the agents are input with current states of the containerized application, wherein the respective agents output respective scheduling actions for the developing of the containerized application, wherein the respective agents comprise respective first graphical neural networks that encode respective topologies of respective cluster partitions of the containerized application that the respective agents oversee.

### BACKGROUND

A containerized application can generally comprise an application architected via multiple inter-communicating microservices that execute in isolated runtime environments (which can be referred to as containers). A container can generally comprise a microservice's dependencies to execute (e.g., libraries and/or configuration files), while excluding an operating system (which can be running outside of the container, and on a host system).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can determine to produce a project schedule for a project of developing a containerized application that comprises a group of microservices. The system can input project specification data into a first artificial intelligence model to produce an output, wherein the project specification data comprises an estimate of an amount of time to complete the project, wherein the output comprises an indication of a user account of a group of user accounts that is responsible for the project, and wherein the first artificial intelligence model produces the output based on a correlation between the project specification data and respective pairs comprising respective project specifications and respective user accounts that were responsible for the respective project specifications. The system can create a dependency map that identifies the group of microservices and respective dependencies between respective microservices of the group of microservices. The system can input the project specification data and the dependency map into a second graphical neural network model that comprises a group of agents, wherein respective agents of the group of agents are input with respective current states of the containerized application, wherein the respective agents output respective scheduling actions for the developing of the containerized application, wherein the respective agents comprise respective first graphical neural networks that encode respective topologies of respective cluster partitions of the containerized application that the respective agents oversee, wherein the respective agents comprise respective second graphical neural networks that encode respective embeddings of the respective cluster partitions of the containerized application, and wherein a goal of the second graphical neural network model is to minimize an average job completion time for the developing of the containerized application. The system can store the project schedule based on the indication of the user account of the group of user accounts that is responsible for the project and the respective scheduling actions for the developing of the containerized application.

An example method can comprise inputting, by a system comprising at least one processor, project specification data into a first artificial intelligence model to produce an output, wherein the project specification data comprises an estimate of an amount of time to complete a project to develop a containerized application that comprises a group of microservices, and wherein the output comprises an indication of a user account of a group of user accounts that is responsible for the project. The method can further comprise inputting, by the system, the project specification data and a dependency map of the group of microservices into a second graphical neural network model that comprises a group of agents, wherein respective agents of the group of agents are input with respective current states of the containerized application, wherein the respective agents output respective scheduling actions to develop the containerized application, wherein the respective agents comprise respective first graphical neural networks that encode respective topologies of respective cluster partitions of the containerized application that the respective agents oversee, wherein the respective agents comprise respective second graphical neural networks that encode respective embeddings of the respective cluster partitions, wherein the second graphical neural network model is configured to minimize an average job completion time to develop the containerized application, and wherein a project schedule comprises the indication of the user account of the group of user accounts that is responsible for the project and the respective scheduling actions to develop the containerized application.

An example non-transitory computer-readable medium can comprise instructions that, in response to execution, cause a system comprising a processor to perform operations. These operations can comprise inputting project specification data into a first artificial intelligence model to produce an output, wherein the project specification data comprises an estimate of an amount of time to complete a project of developing microservices, and wherein the output comprises an indication of a user account of user accounts that is responsible for a project identified by the project specification data. These operations can further comprise inputting the project specification data and a dependency map of the microservices into a second graphical neural network model that comprises agents, wherein respective agents of the agents are input with respective current states of the microservices, wherein the respective agents output respective scheduling actions for the developing of the microservices, wherein the respective agents comprise respective first graphical neural networks that encode respective topologies of respective cluster partitions of the microservices that the respective agents oversee, and wherein a project schedule comprises the indication of the user account and the respective scheduling actions.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate a graphical neural network (GNN)-based project scheduling system for service development for containerized applications, in accordance with an embodiment of this disclosure;

FIG. 2 illustrates another example system architecture that can facilitate a GNN-based project scheduling system for service development for containerized applications, in accordance with an embodiment of this disclosure;

FIG. 3 illustrates an example requirement-owner graph, and that can facilitate a GNN-based project scheduling system for service development for containerized applications, in accordance with an embodiment of this disclosure;

FIG. 4 illustrates an example of a team capacity estimation, and that can facilitate a GNN-based project scheduling system for service development for containerized applications, in accordance with an embodiment of this disclosure;

FIG. 5 illustrates an example scheduling result, and that can facilitate a GNN-based project scheduling system for service development for containerized applications, in accordance with an embodiment of this disclosure;

FIG. 6 illustrates an example process flow that can facilitate a GNN-based project scheduling system for service development for containerized applications, in accordance with an embodiment of this disclosure;

FIG. 7 illustrates another example process flow that can facilitate a GNN-based project scheduling system for service development for containerized applications, in accordance with an embodiment of this disclosure;

FIG. 8 illustrates another example process flow that can facilitate a GNN-based project scheduling system for service development for containerized applications, in accordance with an embodiment of this disclosure;

FIG. 9 illustrates an example block diagram of a computer operable to execute an embodiment of this disclosure.

### DETAILED DESCRIPTION

### Overview

Service development engineering on a containerized application platform can be viewed as an engineering project over the 6Ws (why, what, where, who, when, and how). It can be a complex (and costly) process from the beginning of establishing business goal(s) to the final production delivery. Furthermore, scheduling the roadmap can be challenging. Prior approaches to software-as-a-service (SaaS) project scheduling can involve manual scheduling, with a hierarchy of the requirements distributed to teams to estimate, sort priority, and then integrate together; the overall process can take months to generate a roadmap for one year.

The present techniques can address these problems via a machine learning (ML)-driven approach to generate such schedules automatically with related user input. The present techniques can leverage the following scenario:
A project manager has defined the business requirements to answer Why in a project management system tool;
The architects have already specified that the services are designed as containers running in containerized application clusters (as Where), and included such information in the project management system tool (as What);
The How question about design, test, deploy, and operate are responsibilities of different teams of domain experts (that is, viewed as automatically resolved by the answer to the Who question).

Therefore, an ML model and system according to the present techniques can focus on managing the 3D challenges of who perform what and when.

This can be decomposed as the following two sub-questions:
Who performs what tasks?
When should who perform what tasks?

It can be appreciated that the present examples generally address question 1 before question 2, and there can be examples where question 2 is addressed first.

For question 1 (who performs what tasks), it can be that the business requirements are defined in a system requirement ticket tracking system, engineering requirements are defined in a project management system tool, and the first sub-question can be to assign ownership (based on who has the needed expertise). This can be done either via user input data or with an ML model.

For where, it can be that this information is specified by infrastructure architects and such information is available in a service dependency map (as well as revisions, or new services to be added).

For question 2 (when/who should perform what tasks), the following can be implemented. For each new service or revision requested in each ticket, an assigned expert can provide their estimation of the human-hour needed.

Second, an ML model can follow a dependency to schedule who to perform what tasks and generate the overall roadmap schedule as the final scheduling answer for when.

Through answering questions 1 and 2, the who and what questions are addressed. The remaining problem to address can be when.

To sum, answering who can address assigning ownership based on expertise, and forecasting capacity availability time. Answering what can address required human-hours (which can be estimated by assigned experts), and existing (and future) service located in a dependency relationship as where. Then, when can address a (dependency-based) execution order, and a schedule of each ticket execution.

An ML model for matching who to tasks (what) can be implemented as follows. There can be a history for who performed what (e.g., as a project management system tool ticket owner who finished certain tasks). Given a new ticket, a similarity can be found with previously finished tickets, and most related owners (e.g., top 3) can be selected as candidates to be an owner of the new ticket. In some examples, user input data can be received to make a final choice, or there can be an adjustment for their considerations.

Candidate models can include a decision tree and a random forest. These approaches can utilize ML models to learn patterns from historical data and make predictions about a compatibility between candidates and job openings. They can consider various features, such as skills, qualifications, experience, industry, education, and other relevant factors to generate a matching score or ranking. They can adapt and improve their matching accuracy over time.

A model can leverage correlation, where similar tasks correlate to similar expertise.

An objective of an ML model according to the present techniques can be to follow a dependency to schedule who to perform what tasks and generate the overall roadmap schedule.

In an example scheduler, the 6 W questions are addressed as follows:
What: the computation dependency is specified in the target neural network model as a graph;
How: the target neural network also specifies the details for execution with the dependency;
Why: the reason for computation is;
Who: it is the agent as the scheduler to perform the tasks;
Where: the place for computation will happen is in the ML central processing unit/graphics processing unit (CPU/GPU) cluster; and
When: when to run which computation is the final output.

This design can leverage training a graph neural network (GNN) with feedback loops to perform scheduling.

The present techniques can be implemented to facilitate scheduling service design tasks automatically to domain experts and generating a roadmap schedule.

Compared with prior approaches to project scheduling systems, a difference is that the dependency to other services is unknown, so prior approaches rely on a human providing this information.

Scalability wise, since a service dependency map can comprise a generic scalable solution, the present techniques can scale up well with the service dependency map.

The present techniques can facilitate on-demand rescheduling when a task owner adjusts an estimation of task required time or team capacity changes.

It can be that, in a given quarter, a deployment team spends 9% of its time on schedule planning activities. The present techniques can reduce this amount of time, so that that time can be instead spent on development activities. For a development organization of 500 engineers, this can represent an efficiency gain of roughly 26,000 person hours.

An ML model according to the present techniques can be based on reinforcement learning, such as a GNN.

Schedulers can be agents that use reinforcement learning (RL) to learn placement policies. Each scheduler (Agent) can take, as input, the current state of the cluster and output a scheduling action. An overall objective can be to minimize an average job completion time.

At each scheduler, a hierarchical GNN can be used for encoding each term state. The topology of the cluster partition that the scheduler is overseeing can be encoded by one GNN; this embedding and embeddings from other schedulers can be further encoded by another GNN.

Encoding from the second GNN can be further processed by a policy network to learn placement decisions, towards larger training speed of jobs. Exchanging information among schedulers through hierarchical GNNs can facilitate strategic decisions on which other scheduler to forward a job's task(s) to, in case there is no available team resource to host the job.

A multi-agent reinforcement learning (MARL) framework can be trained offline, driven by a deep neural network (DNN) training interference model, and the learned policy can be executed online for job placement at the respective scheduler, upon new job arrivals.

### Example Architectures, etc.

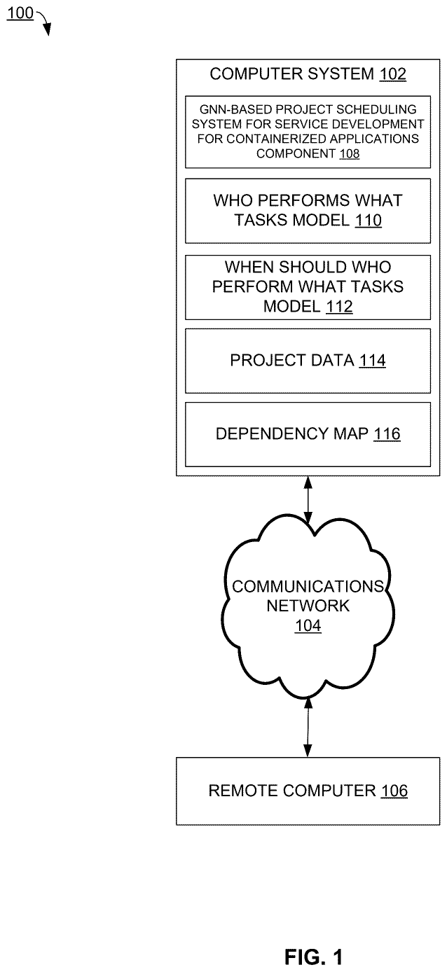

FIG. 1 illustrates an example system architecture 100 that can facilitate a GNN-based project scheduling system for service development for containerized applications, in accordance with an embodiment of this disclosure.

System architecture 100 comprises computer system 102, communications network 104, and remote computer 106. Computer system 102 comprises GNN-based project scheduling system for service development for containerized applications component 108, who performs what tasks model 110, when should who perform what task model 112, project data 114, and dependency map 116.

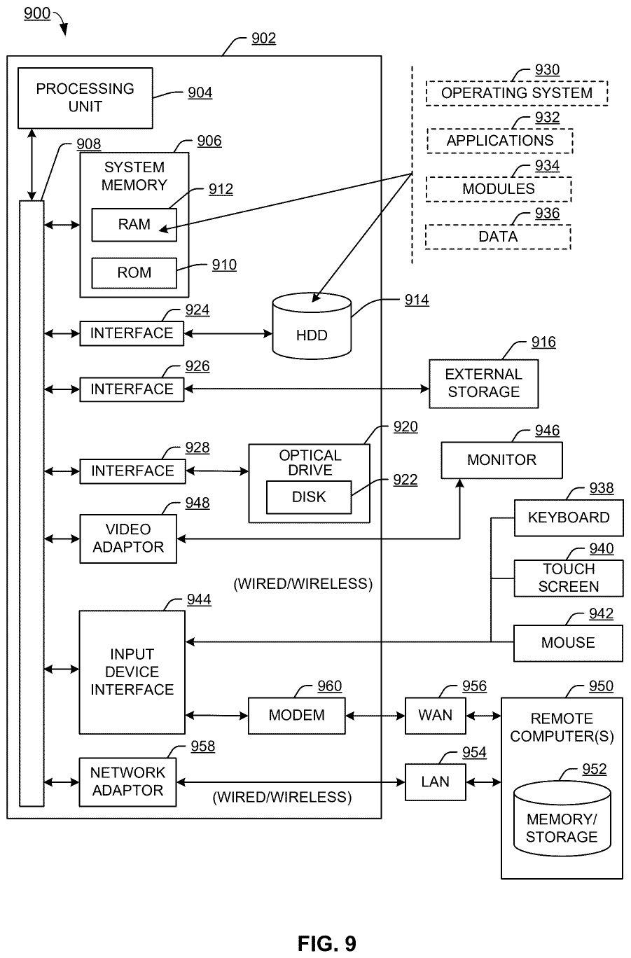

Each of computer system 102 and/or remote computer 106 can be implemented with part(s) of computing environment 900 of FIG. 9. Communications network 104 can comprise a computer communications network, such as the Internet.

Remote computer 106 can access computer system 102 via communications network 104 to prompt determining a project schedule. GNN-based project scheduling system for service development for containerized applications component 108 can orchestrate generation of a corresponding project schedule by leveraging who performs what tasks model 110, when should who perform what task model 112, project data 114, and dependency map 116, as described herein.

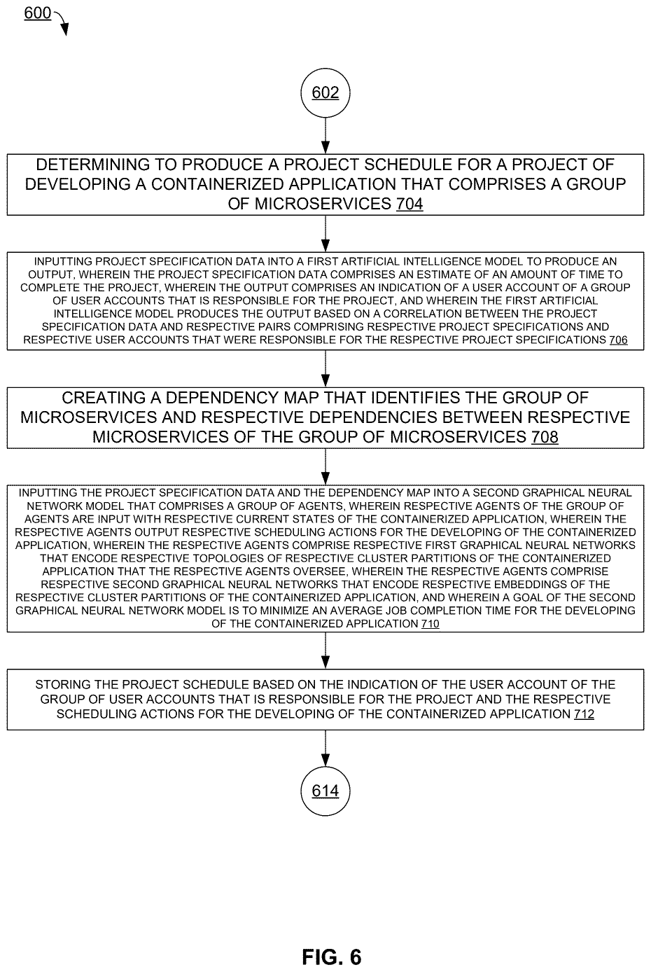

In some examples, GNN-based project scheduling system for service development for containerized applications component 108 can implement part(s) of the process flows of FIGS. 6-9 to implement GNN-based project scheduling system for service development for containerized applications.

It can be appreciated that system architecture 100 is one example system architecture for GNN-based project scheduling system for service development for containerized applications, and that there can be other system architectures that facilitate a GNN-based project scheduling system for service development for containerized applications.

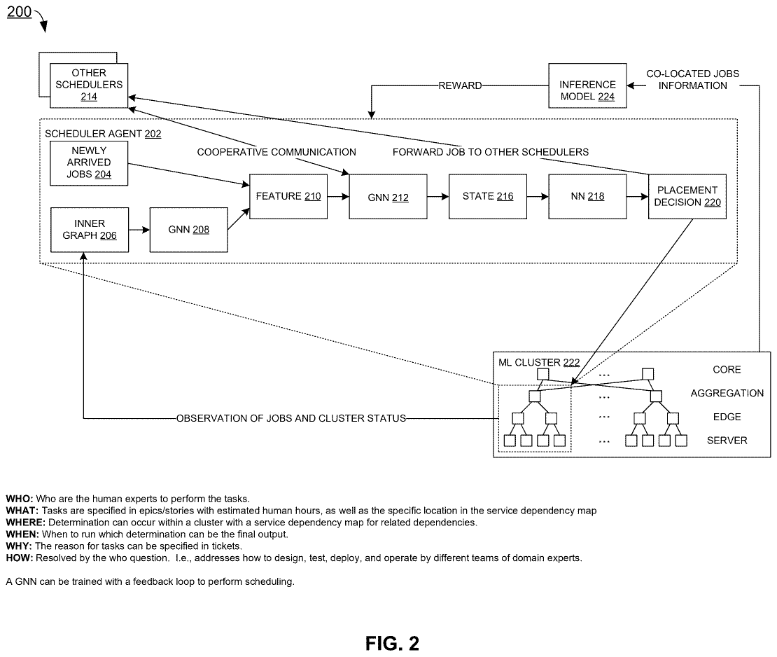

FIG. 2 illustrates another example system architecture 200 that can facilitate a GNN-based project scheduling system for service development for containerized applications, in accordance with an embodiment of this disclosure. In some examples, part(s) of system architecture 200 can be implemented by part(s) of system architecture 100 of FIG. 1 to facilitate a GNN-based project scheduling system for service development for containerized applications.

System architecture 200 comprises scheduler agent 202, newly arrived jobs 204, inner graph 206, graph neural network 208, feature 210, graph neural network 212, other schedulers 214, state 216, neural network 218, placement decision 220, ML cluster 222, and inference model 224.

System architecture 200 illustrates an example of a scheduler to implement the present techniques.

In system architecture 200, the 6 W questions are answered as:
What: the tasks are specified in a project management system tool with estimated human hours, as well as the specific location in a service dependency map;
How: The how question about design, test, deploy, and operate can be responsibilities of different teams of domain experts (that is, viewed as automatically resolved by the who question);
Why: the reasons for tasks are specified in tickets;
Who: it is the human experts to perform the task;
This design relies on training a GNN (Graph Neural Network) with feedback loop(s) to perform scheduling;
Where: the place for computation will happen is in the K8s cluster with service dependency map for related dependency; and
When: when to run which computation is the final output.

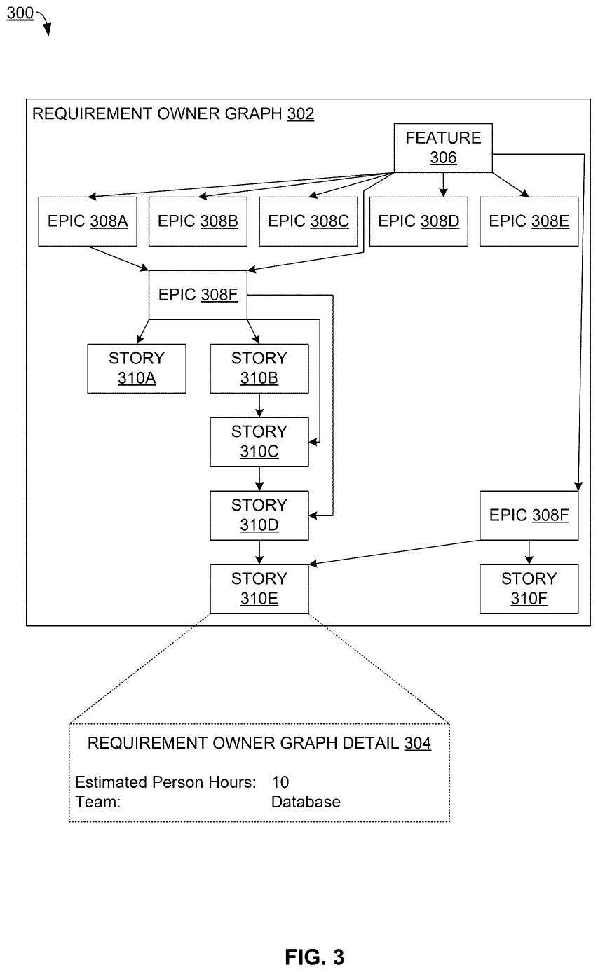

FIG. 3 illustrates an example requirement-owner graph 300, and that can facilitate a GNN-based project scheduling system for service development for containerized applications, in accordance with an embodiment of this disclosure. In some examples, part(s) of requirement-owner graph 300 can be implemented by part(s) of system architecture 100 of FIG. 1 to facilitate a GNN-based project scheduling system for service development for containerized applications.

Example 300 depicts displaying results of answering question 1 as a requirement-owner graph.

Example 300 comprises requirement owner graph 302 and requirement owner graph detail 304. Requirement owner graph 302 comprises feature 306, epic 308A (where an epic generally describes one concept to implement), epic 308B, epic 308C, epic 308D, epic 308E, epic 308F, epic 308G, story 310A (where a story generally defines how a part of an epic is to be accomplished; a relationship between epics and stories can be one epic to multiple stories), story 310B, story 310C, story 310D, story 310E, and story 310F.

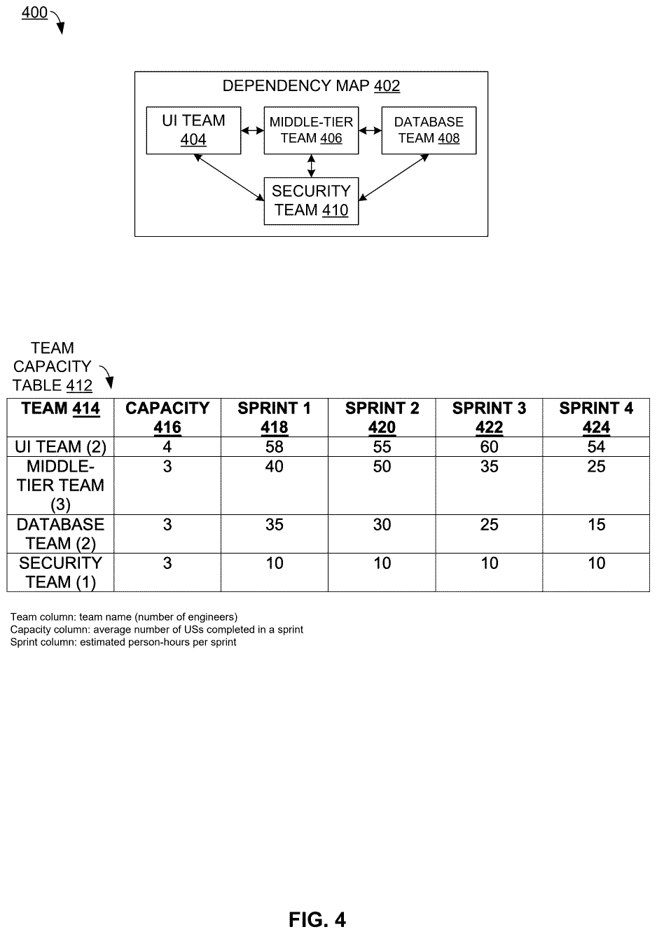

FIG. 4 illustrates an example 400 of a team capacity estimation, and that can facilitate a GNN-based project scheduling system for service development for containerized applications, in accordance with an embodiment of this disclosure. In some examples, part(s) of example 400 can be implemented by part(s) of system architecture 100 of FIG. 1 to facilitate a GNN-based project scheduling system for service development for containerized applications.

Example 400 comprises dependency map 402, which comprises UI team 404, middle-tier team 406, database team 408, and security team 410. Example 400 also comprises team capacity table 412, which comprises team 414, capacity 416, sprint 1 418, sprint 2 420, sprint 3 422, and sprint 4 424.

In example 400, arrows denote the (high level) dependencies between teams when it comes to a project management system tool.
Team column: Team name (number of engineers)
Capacity column: average number of USs completed in a sprint
Sprint column: estimated man-hours per sprint

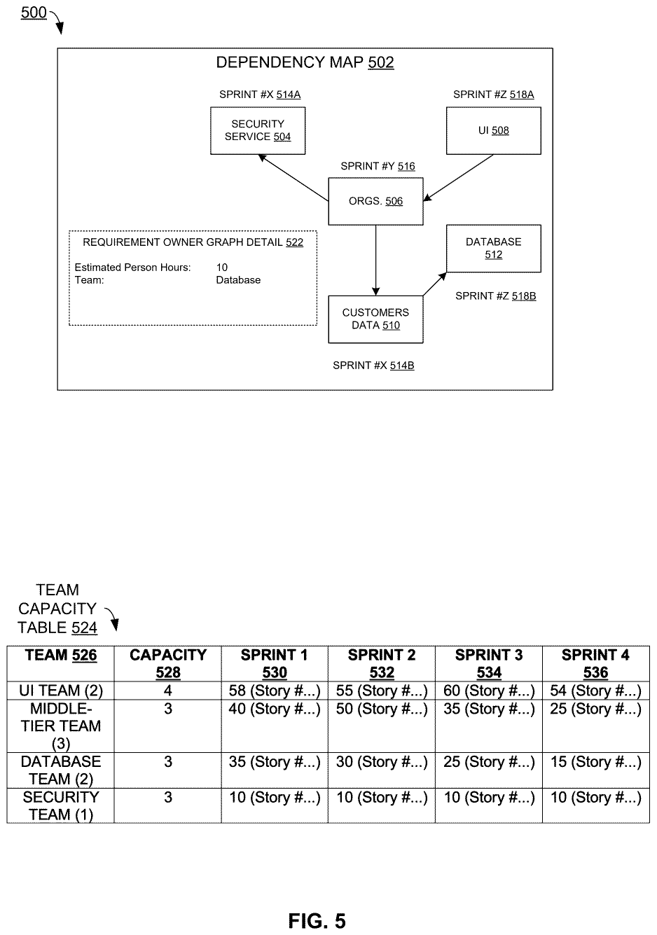

FIG. 5 illustrates an example scheduling result 500, and that can facilitate a GNN-based project scheduling system for service development for containerized applications, in accordance with an embodiment of this disclosure. In some examples, part(s) of scheduling result 500 can be implemented by part(s) of system architecture 100 of FIG. 1 to facilitate a GNN-based project scheduling system for service development for containerized applications.

Example 500 comprises dependency map 502, which comprises security service 504, organizations 506, UI 508, customers data 510, database 512, sprint #x 514A, sprint #x 514B, sprint #y 516, sprint #z 518A, sprint #z 518B, and detail 522. Example 500 also comprises team capacity table 524, which comprises team 526, capacity 528, sprint 1 530, sprint 2 532, sprint 3 534, and sprint 4 536.

Schedule results can be displayed in:
Dependency map: for visualizing the tasks with context;
Team capacity table: for adjusting/prioritizing.

### Example Process Flows

FIG. 6 illustrates another example process flow 600 that can facilitate a GNN-based project scheduling system for service development for containerized applications, in accordance with an embodiment of this disclosure. In some examples, one or more embodiments of process flow 600 can be implemented by GNN-based project scheduling system for service development for containerized applications component 108A and/or GNN-based project scheduling system for service development for containerized applications component 108B of FIG. 1, or computing environment 900 of FIG. 9.

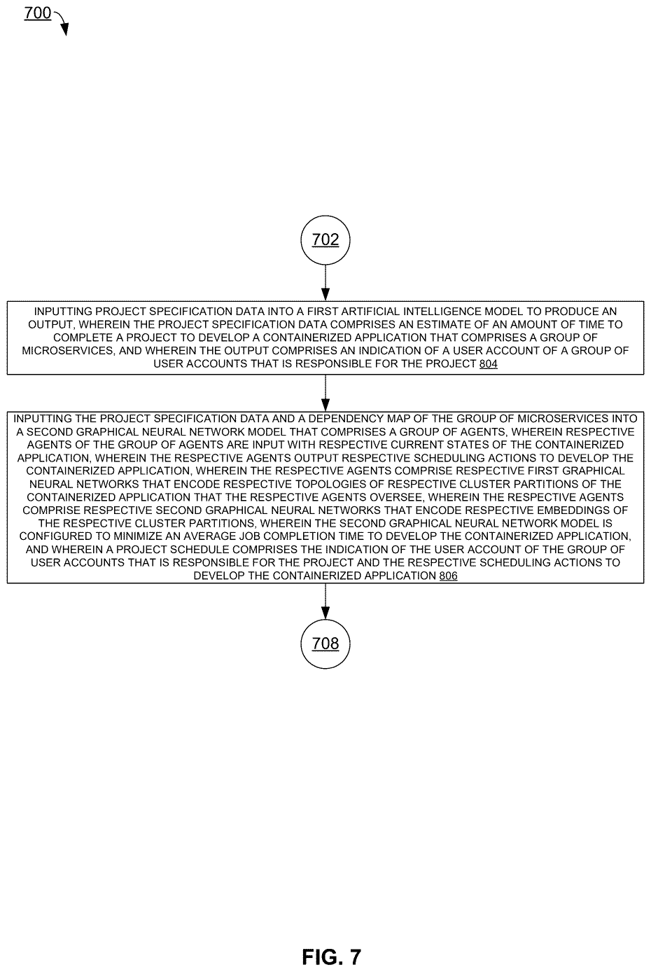

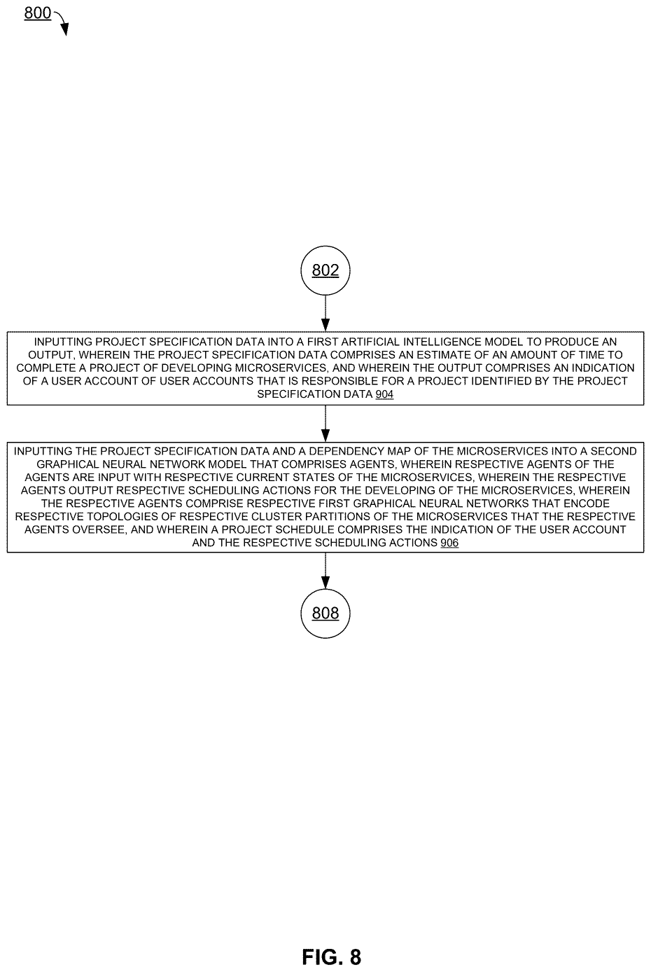

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 700 of FIG. 7, and/or process flow 800 of FIG. 8.

Process flow 600 begins with 602, and moves to operation 604.

Operation 604 depicts determining to produce a project schedule for a project of developing a containerized application that comprises a group of microservices. A project schedule can be a combination of one or more user accounts that are responsible for at least part of the project and scheduling actions for developing a containerized application (e.g., what milestones are to be accomplished in what order and when).

After operation 604, process flow 600 moves to operation 606.

Operation 606 depicts inputting project specification data into a first artificial intelligence model to produce an output, wherein the project specification data comprises an estimate of an amount of time to complete the project, wherein the output comprises an indication of a user account of a group of user accounts that is responsible for the project, and wherein the first artificial intelligence model produces the output based on a correlation between the project specification data and respective pairs comprising respective project specifications and respective user accounts that were responsible for the respective project specifications. This first artificial intelligence model can be similar to who performs what tasks model 110 of FIG. 1.

In some examples, a task in a task management application comprises the project specification data. That is, task management software can be used to manage tasks, and information from that task management software can be leveraged to implement the present techniques.

After operation 606, process flow 600 moves to operation 608.

Operation 608 depicts creating a dependency map that identifies the group of microservices and respective dependencies between respective microservices of the group of microservices. This dependency map can be similar to that depicted in FIG. 5.

After operation 608, process flow 600 moves to operation 610.

Operation 610 depicts inputting the project specification data and the dependency map into a second graphical neural network model that comprises a group of agents, wherein respective agents of the group of agents are input with respective current states of the containerized application, wherein the respective agents output respective scheduling actions for the developing of the containerized application, wherein the respective agents comprise respective first graphical neural networks that encode respective topologies of respective cluster partitions of the containerized application that the respective agents oversee, wherein the respective agents comprise respective second graphical neural networks that encode respective embeddings of the respective cluster partitions of the containerized application, and wherein a goal of the second graphical neural network model is to minimize an average job completion time for the developing of the containerized application. This second artificial intelligence model can be similar to when should who perform what task model 112 of FIG. 1.

In some examples, the respective agents of the graphical neural network model implement reinforcement learning. That is, schedulers for the present techniques can comprise agents that use reinforcement learning to learn placement policies.

In some examples, the respective agents of the second graphical neural network model comprise respective hierarchical graphical neural networks, and wherein the respective hierarchical graphical neural networks comprise the respective first graphical neural networks and the respective second graphical neural networks. That is, it can be that, at each scheduler, hierarchical GNNs can be used for encoding each team state: the topology of the cluster partition that the scheduler is overseeing can be encoded by one GNN; and this embedding and embeddings from other schedulers can be further encoded by another GNN.

In some examples, operation 610 comprises processing the respective embeddings by a policy network, wherein the policy network is configured to make placement decisions based on the respective embeddings. That is, encoding from a second GNN can be further processed by a policy network to learn placement decisions, toward larger training speed of jobs.

In some examples, the respective agents implement multi-agent reinforcement learning. In some examples, the respective agents are trained offline to determine a learned policy. That is, a MARL framework can be trained offline and driven by a DNN training interference model, and the learned policy ca be executed online for job placement at the respective scheduler, upon new job arrivals.

In some examples, the respective agents are configured to exchange information. In some examples, the respective agents are configured to forward tasks of the project specification data to respective other agents of the respective agents. In some examples, an agent of the respective agents forwards a task of the tasks based on the agent lacking available team resources to host the task. That is, information can be exchanged through hierarchical GNNs, which can facilitate strategic decisions on which other scheduler to forward a job's task(s) to, such as where there is no available team resource to host the job.

After operation 610, process flow 600 moves to operation 612.

Operation 612 depicts storing the project schedule based on the indication of the user account of the group of user accounts that is responsible for the project and the respective scheduling actions for the developing of the containerized application. This project schedule can be stored and later used for performing the project.

After operation 612, process flow 600 moves to 614, where process flow 600 ends.

FIG. 7 illustrates another example process flow 700 that can facilitate a GNN-based project scheduling system for service development for containerized applications, in accordance with an embodiment of this disclosure. In some examples, one or more embodiments of process flow 700 can be implemented by GNN-based project scheduling system for service development for containerized applications component 108A and/or GNN-based project scheduling system for service development for containerized applications component 108B of FIG. 1, or computing environment 900 of FIG. 9.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 600 of FIG. 6, and/or process flow 800 of FIG. 8.

Process flow 700 begins with 702, and moves to operation 704.

Operation 704 depicts inputting project specification data into a first artificial intelligence model to produce an output, wherein the project specification data comprises an estimate of an amount of time to complete a project to develop a containerized application that comprises a group of microservices, and wherein the output comprises an indication of a user account of a group of user accounts that is responsible for the project. In some examples, operation 704 can be implemented in a similar manner as operations 604-606 of FIG. 6.

In some examples, the output of the first artificial intelligence model comprises a subgroup of user accounts of the group of user accounts, and wherein the subgroup of user accounts comprises the user account. That is, given a new project management tool application ticket, the first AI model can find similarity of the previous finished tickets, and choose the most related (e.g., top 3) owners as the candidates of the new ticket owners.

In some examples, the first artificial intelligence model comprises a decision tree model. A decision tree model can generally comprise a supervised learning model that is configured to draw conclusions from a group of observations.

In some examples, the first artificial intelligence model comprises a random forest model. A random forest model can generally comprise a model that creates multiple decision trees during training, then during inference, performs classification based on an output of a class selected by the most decision trees.

In some examples, the output of the first artificial intelligence model is based on respective skills associated with the respective user accounts, respective qualifications associated with the respective user accounts, respective experience associated with the respective user accounts, respective industries associated with the respective user accounts, or respective educations associated with the respective user accounts. That is, the first AI model can consider various features such as skills, qualifications, experience, industry, education, and other relevant factors to generate a matching score or ranking.

After operation 704, process flow 700 moves to operation 706.

Operation 706 depicts inputting the project specification data and a dependency map of the group of microservices into a second graphical neural network model that comprises a group of agents, wherein respective agents of the group of agents are input with respective current states of the containerized application, wherein the respective agents output respective scheduling actions to develop the containerized application, wherein the respective agents comprise respective first graphical neural networks that encode respective topologies of respective cluster partitions of the containerized application that the respective agents oversee, wherein the respective agents comprise respective second graphical neural networks that encode respective embeddings of the respective cluster partitions, wherein the second graphical neural network model is configured to minimize an average job completion time to develop the containerized application, and wherein a project schedule comprises the indication of the user account of the group of user accounts that is responsible for the project and the respective scheduling actions to develop the containerized application. In some examples, operation 706 can be implemented in a similar manner as operations 608-610 of FIG. 6.

After operation 706, process flow 700 moves to 708, where process flow 700 ends.

FIG. 8 illustrates another example process flow 800 that can facilitate a GNN-based project scheduling system for service development for containerized applications, in accordance with an embodiment of this disclosure. In some examples, one or more embodiments of process flow 800 can be implemented by GNN-based project scheduling system for service development for containerized applications component 108A and/or GNN-based project scheduling system for service development for containerized applications component 108B of FIG. 1, or computing environment 900 of FIG. 9.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 600 of FIG. 6, and/or process flow 700 of FIG. 7.

Process flow 800 begins with 802, and moves to operation 804.

Operation 804 depicts inputting project specification data into a first artificial intelligence model to produce an output, wherein the project specification data comprises an estimate of an amount of time to complete a project of developing microservices, and wherein the output comprises an indication of a user account of user accounts that is responsible for a project identified by the project specification data. In some examples, operation 804 can be implemented in a similar manner as operations 604-606 of FIG. 6.

After operation 804, process flow 800 moves to operation 806.

Operation 806 depicts inputting the project specification data and a dependency map of the microservices into a second graphical neural network model that comprises agents, wherein respective agents of the agents are input with respective current states of the microservices, wherein the respective agents output respective scheduling actions for the developing of the microservices, wherein the respective agents comprise respective first graphical neural networks that encode respective topologies of respective cluster partitions of the microservices that the respective agents oversee, and wherein a project schedule comprises the indication of the user account and the respective scheduling actions. In some examples, operation 806 can be implemented in a similar manner as operations 608-610 of FIG. 6.

In some examples, operation 806 comprises producing an updated project schedule based on an adjustment of estimated time to perform a task associated with the project specification data, or based on an adjustment of team capacity changes associated with the project specification data. That is, on-demand rescheduling can be performed, such as when a task owner adjusts an estimation of a task's required time or a team capacity changes.

In some examples, the dependency map is a first dependency map, and operation 806 comprises displaying the project schedule in a user interface that comprises a second dependency map. The second dependency map can be similar to dependency map 502 of FIG. 5.

In some examples, operation 806 comprises displaying the project schedule in a user interface that comprises a tabular representation of the project schedule. The tabular representation can be similar to team capacity table 524 of FIG. 5.

In some examples, operation 806 comprises displaying a requirement-owner graph based on the project specification data and the output of the first artificial intelligence model. This can be similar to example 300 of FIG. 3.

After operation 806, process flow 800 moves to 808, where process flow 800 ends.

### Example Operating Environment

In order to provide additional context for various embodiments described herein, FIG. 9 and the following discussion are intended to provide a brief, general description of a suitable computing environment 900 in which the various embodiments of the embodiment described herein can be implemented.

For example, parts of computing environment 900 can be used to implement one or more embodiments of computer system 102, and/or remote computer 106.

In some examples, computing environment 900 can implement one or more embodiments of the process flows of FIGS. 6-9 to facilitate a GNN-based project scheduling system for service development for containerized applications.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a nonvolatile storage such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the . NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples, and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips...), optical discs (e.g., CD, DVD...), smart cards, and flash memory devices (e.g., card, stick, key drive...). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
determining to produce a project schedule for a project of developing a containerized application that comprises a group of microservices;
inputting project specification data into a first artificial intelligence model to produce an output,
wherein the project specification data comprises an estimate of an amount of time to complete the project,
wherein the output comprises an indication of a user account of a group of user accounts that is responsible for the project, and
wherein the first artificial intelligence model produces the output based on a correlation between the project specification data and respective pairs comprising respective project specifications and respective user accounts that were responsible for the respective project specifications;
creating a dependency map that identifies the group of microservices and respective dependencies between respective microservices of the group of microservices;
inputting the project specification data and the dependency map into a second graphical neural network model that comprises a group of agents,
wherein respective agents of the group of agents are input with respective current states of the containerized application,
wherein the respective agents output respective scheduling actions for the developing of the containerized application,
wherein the respective agents comprise respective first graphical neural networks that encode respective topologies of respective cluster partitions of the containerized application that the respective agents oversee,
wherein the respective agents comprise respective second graphical neural networks that encode respective embeddings of the respective cluster partitions of the containerized application, and
wherein a goal of the second graphical neural network model is to minimize an average job completion time for the developing of the containerized application; and
storing the project schedule based on the indication of the user account of the group of user accounts that is responsible for the project and the respective scheduling actions for the developing of the containerized application.

2. The system of claim 1, wherein a task in a task management application comprises the project specification data.

3. The system of claim 1, wherein the respective agents of the graphical neural network model implement reinforcement learning.

4. The system of claim 1, wherein the respective agents of the second graphical neural network model comprise respective hierarchical graphical neural networks, and wherein the respective hierarchical graphical neural networks comprise the respective first graphical neural networks and the respective second graphical neural networks.

5. The system of claim 1, wherein the operations further comprise:
processing the respective embeddings by a policy network, wherein the policy network is configured to make placement decisions based on the respective embeddings.

6. The system of claim 1, wherein the respective agents implement multi-agent reinforcement learning.

7. The system of claim 1, wherein the respective agents are trained offline to determine a learned policy.

8. The system of claim 1, wherein the respective agents are configured to exchange information.

9. The system of claim 1, wherein the respective agents are configured to forward tasks of the project specification data to respective other agents of the respective agents.

10. The system of claim 8, wherein an agent of the respective agents forwards a task of the tasks based on the agent lacking available team resources to host the task.

11. A method, comprising:
inputting, by a system comprising at least one processor, project specification data into a first artificial intelligence model to produce an output, wherein the project specification data comprises an estimate of an amount of time to complete a project to develop a containerized application that comprises a group of microservices, and wherein the output comprises an indication of a user account of a group of user accounts that is responsible for the project; and
inputting, by the system, the project specification data and a dependency map of the group of microservices into a second graphical neural network model that comprises a group of agents, wherein respective agents of the group of agents are input with respective current states of the containerized application, wherein the respective agents output respective scheduling actions to develop the containerized application, wherein the respective agents comprise respective first graphical neural networks that encode respective topologies of respective cluster partitions of the containerized application that the respective agents oversee, wherein the respective agents comprise respective second graphical neural networks that encode respective embeddings of the respective cluster partitions, wherein the second graphical neural network model is configured to minimize an average job completion time to develop the containerized application, and wherein a project schedule comprises the indication of the user account of the group of user accounts that is responsible for the project and the respective scheduling actions to develop the containerized application.

12. The method of claim 11, wherein the output of the first artificial intelligence model comprises a subgroup of user accounts of the group of user accounts, and wherein the subgroup of user accounts comprises the user account.

13. The method of claim 11, wherein the first artificial intelligence model comprises a decision tree model.

14. The method of claim 11, wherein the first artificial intelligence model comprises a random forest model.

15. The method of claim 11, wherein the output of the first artificial intelligence model is based on respective skills associated with the respective user accounts, respective qualifications associated with the respective user accounts, respective experience associated with the respective user accounts, respective industries associated with the respective user accounts, or respective educations associated with the respective user accounts.

16. A non-transitory computer-readable medium comprising instructions that, in response to execution, cause a system comprising at least one processor to perform operations, comprising:
inputting project specification data into a first artificial intelligence model to produce an output, wherein the project specification data comprises an estimate of an amount of time to complete a project of developing microservices, and wherein the output comprises an indication of a user account of user accounts that is responsible for a project identified by the project specification data; and
inputting the project specification data and a dependency map of the microservices into a second graphical neural network model that comprises agents, wherein respective agents of the agents are input with respective current states of the microservices, wherein the respective agents output respective scheduling actions for the developing of the microservices, wherein the respective agents comprise respective first graphical neural networks that encode respective topologies of respective cluster partitions of the microservices that the respective agents oversee, and wherein a project schedule comprises the indication of the user account and the respective scheduling actions.

17. The non-transitory computer-readable medium of claim 16, wherein the operations further comprise:
producing an updated project schedule based on an adjustment of estimated time to perform a task associated with the project specification data, or based on an adjustment of team capacity changes associated with the project specification data.

18. The non-transitory computer-readable medium of claim 16, wherein the dependency map is a first dependency map, and wherein the operations further comprise:
displaying the project schedule in a user interface that comprises a second dependency map.

19. The non-transitory computer-readable medium of claim 16, wherein the operations further comprise:
displaying the project schedule in a user interface that comprises a tabular representation of the project schedule.

20. The non-transitory computer-readable medium of claim 16, wherein the operations further comprise:
displaying a requirement-owner graph based on the project specification data and the output of the first artificial intelligence model.
